(19) United States
(12) Patent Application Publication
(10) Pub. No.: US 2026/0205925 A1
(43) Pub. Date: Jul. 16, 2026

(54) METHOD AND APPARATUS FOR FLEXIBLE SERVICE DATA TRANSMISSION IN WIRELESS COMMUNICATION SYSTEM

(71) Applicant: Samsung Electronics Co., Ltd., Gyeonggi-do (KR)

(72) Inventors: Dongeun SUH, Gyeonggi-do (KR); Hoyeon LEE, Gyeonggi-do (KR); Hyesung KIM, Gyeonggi-do (KR); Taehyung LIM, Gyeonggi-do (KR)

(21) Appl. No.: 19/443,474

(22) Filed: Jan. 8, 2026

(30) Foreign Application Priority Data
Jan. 10, 2025 (KR) 10-2025-0004230

(51) Int. Cl. H04W 48/16; H04W 76/10

(52) U.S. Cl. CPC H04W 48/16; H04W 76/10

(57) ABSTRACT

The present disclosure relates to a 5G communication system or a 6G communication system for supporting higher data rates beyond a 4G communication system such as long term evolution (LTE). A method performed by a network entity includes receiving a UP connection establishment request message from a user UE; transmitting a NF discovery request message; receiving a response message including an NF profile; selecting a service NF entity based on the received NF profile; transmitting, to the selected service NF entity, identification information of the UE and the received UP connection establishment request message; receiving, from the selected service NF entity, a message including binding identification information corresponding to the UE identification information and/or address information of the selected service NF entity; transmitting, to the UE, a NAS message including the binding identification information and/or the address information of the selected service NF entity; receiving, from the UE, information indicating whether a UP connection with the selected service NF entity is established; and transmitting, to the selected service NF entity, the information indicating whether the UP connection is established.

### CROSS-REFERENCE TO RELATED APPLICATION(S)

This application is based on and claims priority under 35 U.S.C. § 119 to Korean Patent Application No. 10-2025-0004230, which was filed in the Korean Intellectual Property Office on Jan. 10, 2025, the entire disclosure of which is incorporated herein by reference.

### BACKGROUND

### 1. Field

The disclosure relates generally to a method and an apparatus for flexible service data transmission, and more particularly to a method and an apparatus for supporting flexible service data transmission in a wireless communication system.

### 2. Description of Related Art

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6 th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive eXtended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

An aspect of the disclosure is to provide an apparatus and a method capable of effectively providing services in a wireless communication system.

In accordance with an aspect of the disclosure, a method is provided for processing a control signal in a wireless communication system. The method may include receiving a first control signal transmitted from a base station, processing the received first control signal, and transmitting, to the base station, a second control signal generated based on the processing.

For example, embodiments of the disclosure can provide an apparatus and a method capable of effectively providing services in a wireless communication system.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network system according to an embodiment;

FIG. 2 illustrates an example of a control plane (CP)-based service support method and a user plane (UP)-based service support method according to an embodiment;

FIG. 3 is a signal flow diagram illustrating a registration procedure of a terminal according to an embodiment;

FIG. 4 is a signal flow diagram illustrating a procedure for controlling a service-specific UP connection according to an embodiment;

FIG. 5 illustrates a UE according to an embodiment;

FIG. 6 illustrates a base station according to an embodiment; and

FIG. 7 illustrates a network entity according to an embodiment.

### DETAILED DESCRIPTION

Hereinafter, various operation principles of the disclosure will be described in detail in conjunction with the accompanying drawings. In the following description of the disclosure, a detailed description of known functions or configurations incorporated herein will be omitted when it is determined that the description may make the subject matter of the disclosure unnecessarily unclear. Furthermore, the terms described below are terms defined in consideration of functions in the disclosure. They may be different according to users, intentions of the users, or customs, and therefore, the definitions of the terms should be made based on the contents throughout the specification.

In the accompanying drawings, some elements may be exaggerated, omitted, or schematically illustrated. Also, the size of each element does not completely reflect the actual size thereof. In the respective drawings, the same or corresponding elements may be assigned the same reference numerals.

Advantages and features of the present disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” may refer to a software element or a hardware element, such as a field programmable gate array (FPGA) or an application specific integrated circuit (ASIC), and a “unit” may perform certain functions. However, the term “unit” does not always have a meaning limited to software or hardware. A “unit” may be constructed either to be stored in an addressable storage medium or to execute one or more processors. Therefore, the term “unit” may include, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, a “unit” in embodiments may include one or more processors.

In the disclosure, terms referring to network entities or network functions and entities of edge computing systems, terms referring to messages, terms referring to identification information, and the like are illustratively used for the convenience of description. Therefore, the disclosure is not limited by the terms as described below, and other terms referring to subjects having equivalent technical meanings may also be used.

In the following description of the disclosure, terms and names defined in 5G system (5GS) and new radio (NR) standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. In particular, the disclosure may be applied to 3GPP NR (e.g., a 5G mobile communication standard) and 6G network systems. In addition, the disclosure may also be applied to other communication systems having similar technical backgrounds or channel types. Moreover, based on determinations by those skilled in the art, the embodiments of the disclosure may also be applied to other communication systems through some modifications without significantly departing from the scope of the disclosure.

A 5G mobile communication network may include a 5G user equipment (UE), a 5G radio access network (RAN), and a 5G core network (CN). The 5G CN may include NFs, such as an access and mobility management function (AMF) that provides a mobility management (MM) function of a UE, a session management function (SMF) that provides an SMF, a user plane function (UPF) that serves to transfer data, a policy control function (PCF) that provides a PCF, a unified data management (UDM) that provides a function to manage data, such as subscriber data and policy control data, and a unified data repository (UDR) that stores data of various NFs such as the UDM. The above example is not limiting, and the 5G CN may include a larger or smaller number of NFs than those described above.

In a 5G system, “network slicing technology” may refer to a technology and a structure that enables multiple virtualized and independent logical networks in one physical network. A network service provider may provide a service by configuring a virtual end-to-end network referred to as a network slice in order to satisfy specialized requirements of services/applications. A network slice is identified by an identifier (ID) referred to as single-network slice selection assistance information (S-NSSAI), and a network service provider may provide a network slice (or slices) to a UE so as to enable the UE to receive a service.

In a 5G system, when a UE performs network registration, the UE may transmit, to an AMF, ID information (i.e., requested S-NSSAIs) for network slices that the UE intends to request, and the AMF may provide, to the UE, information (allowed NSSAI) on network slices available to the UE, in consideration of the requested S-NSSAIs and subscriber information. Even when the UE does not provide the information on the requested slices, the AMF may provide the allowed NSSAI to the UE. In this case, the allowed NSSAI may include information on default configured slices (Default Configured NSSAI) and information on slices configured by default (i.e., Default Subscribed S-NSSAIs) among subscribed slices included in UE subscriber information.

When no slice may be included in the allowed NSSAI (e.g., when the default configured NSSAI and the default subscribed S-NSSAI are absent or unavailable), the AMF may transmit, to the UE, a network registration rejection message including a cause code indicating registration rejection due to the absence of available slices.

When a certain slice is to be included in the allowed NSSAI of the UE, a network slice admission control (NSAC) procedure and a network slice-specific authentication and authorization (NSSAA) procedure may be performed for the corresponding slice. In the NSAC procedure, whether a specific slice is allowed may be determined based on the number of UEs currently registered for the corresponding slice and the maximum number of registered UEs allowed for the corresponding slice (i.e., whether the corresponding slice is included in the allowed NSSAI is determined). Specifically, an NSAC function (NSACF) may monitor, for network slices to be subject to NSAC, the number of registered UEs and the number of established packet data unit (PDU) sessions for each slice, and may perform control so that the number of registered UEs and the number of established PDU sessions for each slice remain below the maximum number of registered UEs and the maximum number of PDU sessions, respectively. In this case, when a new UE is registered for, or an existing registered UE is deregistered from, a slice to be subject to NSAC, the AMF may transmit, to the NSACF, an update request message for notifying the NSACF of the registration of the new UE or the deregistration of the existing registered UE. When a new PDU session is generated for, or an existing PDU session is released from, a slice to be subject to NSAC, an SMF may transmit, to the NSACF, an update request message for notifying the NSACF of the generation of the new PDU session or the release of the existing PDU session. When the NSACF receives a message indicating registration of a new UE to a slice or a message indicating generation of a new PDU session, the NSACF may determine whether the UE registration or PDU session generation is allowed, based on the maximum number of UEs and the maximum number of PDU sessions for the corresponding slice, and then include the result of the determination in each response message.

To transmit and receive data to and from a specific data network (DN) through allowed slices (allowed NSSAIs), the UE may select one of the allowed slices, request generation of a PDU session to a specific DN name (DNN) in the selected slice, and transmit and receive data through the generated PDU session. A PDU session may include multiple traffic flows. The traffic flows may include two types: a guaranteed bitrate (GBR) quality-of-service (QoS) flow and a non-GBR QoS flow.

A situation in which a network slice becomes unavailable may occur (e.g., when congestion has occurred in various 5G network entities belonging to a certain network slice, or the use of a specific slice is required to be temporarily or permanently suspended for operational reasons (e.g., equipment replacement and upgrade), when application traffic is required to be moved to a different slice due to performance degradation of a network slice transmitting the application traffic, etc.), and a function of providing a service through an alternative network slice may exist for service continuity. Specifically, in order to replace an S-NSSAI being used by the UE with an alternative S-NSSAI (i.e., an alternative network slice), the network may transmit, to the UE, information (e.g., mapping information) indicating that the alternative S-NSSAI is to be used instead of the S-NSSAI.

The AMF may transmit, to the UE, information indicating that the alternative S-NSSAI is to be used instead of the S-NSSAI. After the AMF transmits, to the UE, the information indicating that the alternative S-NSSAI is to be used, if the replaced S-NSSAI is not supported in the current tracking area (TA) of the UE or in a serving cell of the UE due to the movement of the UE or the like, a method for processing a PDU session associated with the replaced S-NSSAI or configuration information of the UE may be required.

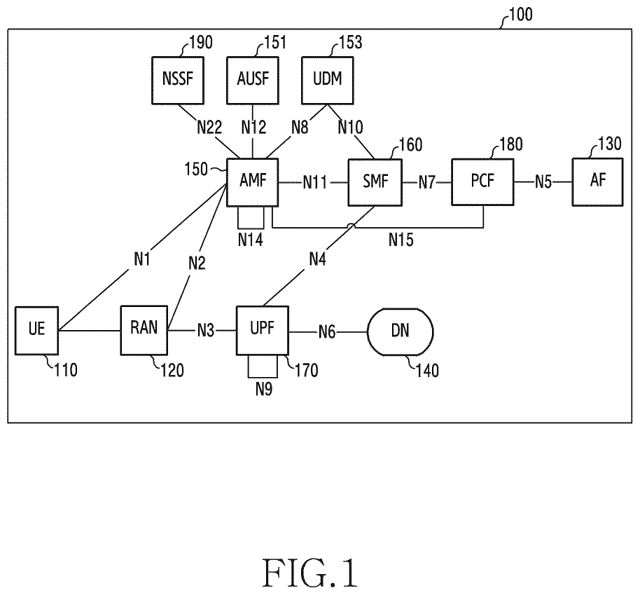

FIG. 1 illustrates a network system according to an embodiment.

Referring to FIG. 1, a 5G mobile communication network may include a 5G UE (or terminal) 110, a 5G RAN (or a base station, a 5g NodeB (gNB), an evolved NodeB (eNB), etc.) 120, and a 5G CN. The 5G CN may include NFs, such as an AMF that provides an MM function of a UE, an SMF that provides an SMF, a UPF that serves to transfer data, a PCF that provides a PCF, a UDM that provides a function to manage data, such as subscriber data and policy control data, and a UDR that stores data of various NFs such as the UDM. The above example is not limiting, and the 5G CN may include a larger or smaller number of layers.

The UE 110 may perform communication through a radio channel, i.e., an access network (AN), established between the UE and a base station (e.g., eNB or gNB). In some embodiments, the UE 110 refers to a device used by a user, and may be a device configured to provide a user interface (UI). For example, the UE 110 may be a UE equipped in a vehicle for driving. In some embodiments, the UE 110 may be an autonomous vehicle or a device that performs machine type communication (MTC) operated without the user's involvement. In addition to the term “electronic device”, the UE may be referred to as a “terminal”, a “vehicle terminal”, a “UE”, a “mobile station”, a “subscriber station”, a “remote terminal”, a “wireless terminal”, “a user device”, or other terms having a technical meaning equivalent thereto. As a UE device, not only the UE, but also a customer-premises equipment (CPE) or a dongle type UE may be used. The CPE may be connected to an NG-RAN node like a UE, and may provide a network to other communication equipment (e.g., laptop).

The AMF 150 may provide a function for access and mobility management in a unit of the UE 110, and by default, one UE 110 may be connected to one AMF 150. Specifically, the AMF 150 may perform at least one function among signaling between CN nodes for mobility between 3GPP ANs, an interface (N2 interface) between RANs (e.g., 5G RAN) 120, non-access stratum (NAS) signaling with the UE 110, identification of the SMF 160, and delivery of a session management (SM) message between the UE 110 and the SMF 160. Some or all functions of the AMF 150 may be supported within a single instance of one AMF 150.

The SMF 160 may provide an SMF, and if the UE 110 has multiple sessions, the sessions may be managed by different SMFs 160, respectively. Specifically, the SMF 160 may perform at least one function among SM (e.g., session establishment, modification, and release, including tunnel maintenance between the UPF 170 and the AN node), selection and control of a UP function, a configuration of traffic steering for routing traffic from the UPE 170 to an appropriate destination, termination of an SM part of an NAS message, downlink data notification (DDN), and delivery of AN-specific SM information to the AN through the N2 interface via an initiator (e.g., AMF 150). Some or all functions of the SMF 160 may be supported within a single instance of one SMF 160.

As used herein, conceptual links connecting NFs in the 5G system may be referred to as “reference points”. The reference points may also be referred to as “interfaces”. The following exemplifies reference points (hereinafter interchangeably used with “interfaces”) included in the 5G system architecture represented throughout various embodiments of the disclosure.
N1: A reference point between a UE 110 and an AMF 150
N2: A reference point between an (R)AN 120 and an AMF 150
N3: A reference point between an (R)AN 120 and a UPF 170
N4: A reference point between an SMF 160 and a UPF 170
N5: A reference point between a PCF 180 and an AF 130
N6: A reference point between a UPF 170 and a DN 140
N7: A reference point between an SMF 160 and a PCF 180
N8: A reference point between a UDM 153 and an AMF 150
N9: A reference point between two core UPFs 170
N10: A reference point between a UDM 153 and an SMF 160
N11: A reference point between an AMF 1590 and an SMF 160
N12: A reference point between an AMF 150 and an authentication server function (AUSF) 151
N13: A reference point between a UDM and an AUSF 151
N14: A reference point between two AMFs 150
N15: A reference point between a PCF 180 and an AMF 150 for a non-roaming scenario, and a reference point between a PCF 180 in a visited network and an AMF 150 for a roaming scenario

In a 5G system, a network slicing technology refers to a technology and a structure that enable multiple virtualized and independent logical networks to be implemented in one physical network. A network service provider may provide a service by configuring a virtual end-to-end network referred to as a network slice in order to satisfy specialized requirements of services/applications. A network slice may be identified by an ID referred to as S-NSSAI. The network transmits, to a UE, a set of slices (e.g., allowed NSSAI(s)) allowed for the UE in a UE registration procedure (e.g., UE registration procedure). The UE may transmit and receive application data through a PDU session established through one S-NSSAI (i.e., network slice) among network slices included in the set of slices allowed for the UE and transmitted from the network to the UE.

In a 6G system, a mobile communication network may be defined as an evolved form of a 5G mobile communication network. Herein, a RAN in 6G may be referred to as a 6G RAN, and 6G NFs included in a CN of 6G may be referred to as an evolved AMF (eAMF), an evolved SMF (eSMF), an evolved UPF (eUPF), etc., as terms corresponding to 5G NFs such as an AMF, an SMF, and a UPF, etc. Additionally, entities included in the RAN of 6G and the CN of 6G may be referred to by other names.

A 6G RAN and a 6G CN may additionally support the following functions compared to a 5G RAN and a 5G CN.
6G RAN: In the case of a 6G RAN, e.g., a wake-up signal (WUS)-based energy saving function may be supported as a basic function. The energy saving function may refer to a function of switching to a sleep mode (a state of low power consumption in which some functions are not supported) and waking up to perform a normal operation (supporting all functions) only when a WUS is received from a UE.
The 6G RAN may utilize AI functions for various basic operations such as channel state prediction, downlink traffic scheduling, uplink packet scheduling, radio resource management, and handover. To this end, the 6G RAN may provide an AI model management function suitable for each purpose, an AI model application function (AF) according to a changed situation, a data collection and training function for training an AI model, and an AI model-based inference function.
The 6G RAN may support various radio access technologies (RATs), and may support multi-RAT spectrum sharing (MRSS) which allows dynamic sharing of frequencies among various RATs.
Compared to the 5G RAN which communicated with the 5G CN only through an AMF, the 6G RAN may provide an interface for directly communicating with various NFs of the 6G CN. For example, the 6G RAN may directly communicate with an NF (e.g., which may be located in an eSMF or a 6G SMF) which provides an SMF of the 6G CN. The 6G RAN may support not only a stream control transmission protocol (SCTP)-based protocol but also, for example, a service-based interface (SBI) based on a hypertext transfer protocol (HTTP) protocol and/or quick UDP internet connections (QUIC), and may communicate with other NFs and RANs through the SBI.
The 6G CN may provide an interface for communication with the 6G RAN and a 6G UE. The 6G CN may provide interfaces with the 6G UE not only through a CP but also through a UP.
The 6G CN may provide functions such as MM, connection management, authentication, policy, and service/data exposure functions. The 6G CN may provide various services such as a converged computing service, an integrated sensing and communication service (ISAC), a non-3GPP sensing service, and AI/machine learning (ML).

In a 6G system, a mobile communication network may include a 6G UE (or terminal), a 6G RAN (or base station, evolved gNB (egNB), etc.), and a 6G CN. The 6G CN may include NFs such as an evolved AMF (eAMF) that provides an MM function of a UE, an evolved SMF (eSMF) that provides an SMF, an evolved UPF (eUPF) which performs a data transfer role, an evolved PCF (ePCF) which provides a PCF, an evolved UDM (eUDM) that provides a data management function such as subscriber data and policy control data, and an evolved UDR (eUDR) that stores data of various NFs. The 6G CN is not limited to the above examples and may include more or fewer NFs.

Herein, a reference point connecting NFs in the 6G system may be similarly expressed by adding “evolved” to each network entity (NF) (e.g., an AMF) in a 5G system architecture. For example, referring to FIG. 1, an AMF may be expressed in the form of an evolved AMF (eAMF).

The types of entities in a 6G system architecture are not limited thereto. For example, an entity (i.e., a 6G entity) in the 6G system architecture corresponding to an entity (i.e., a 5G entity) in the 5G system architecture shown in FIG. 1 may include some or all of functions of the 5G entity, and may also include other functions for 6G services. For example, an eAMF in the 6G system may provide functions for UE MM, authentication management, and connection management with the UE, which are provided by the AMF in the 5G system.

Herein, a reference point between 6G entities may be expressed similarly to the name of a reference point between 5G entities. For example, referring to FIG. 1, N1 in the 5G system may be replaced by a different reference point name (e.g., N1+) in the 6G system.

A UE may support various 5G/6G services, and for each service, the UE may communicate with an NF (i.e., a service NF) which provides a service. The term “service NF” as used herein may refer to an NF that communicates with the UE for a specific service. Non-limiting examples of the service NF may include:
Location service (LCS): This may refer to a service that provides the location of the UE or a service which receives the location of the UE from the network. In the case of this service, an NF corresponding to the service NF may be an NF that provides the LCS, and may be referred to as an LMF or an eLMF.
Sensing service: This may refer to a service through UE-based sensing information. This service may include object detection, fall detection, user health information (e.g., heart rate, blood pressure information, etc.), speed and location information, and a collision notification service. In the case of this service, an NF corresponding to the service NF may be an NF that provides the sensing service, and may be referred to as a sensing NF, an ISAC NF, etc.
AI Data collection service: This may refer to a service which collects data for AI model training for AI model-based communication. This service may include a function of transmitting, by the UE, data for AI model training to the network, a function of receiving, by the UE, data for AI model training from the network, etc. In the case of this service, an NF corresponding to the service NF provides a data collection and provision service, and may be referred to as a data collection NF (DCNF), an AI NF, a data service NF (DSNF), etc.
UE Policy service: This may refer to a service in which a home public land mobile network (PLMN) provides, to the UE, policy information that the UE is required to follow. This service may include a UE route selection policy (URSP) rule (i.e., a rule indicating which network path the UE is required to use with respect to traffic to be transmitted and received. The UE may determine, based on the URSP rule, the DNN and/or network slice of a session through which application traffic is to be transmitted or received.), an AN selection rule (e.g., a rule indicating which non-3GPP AN the UE is to select), etc. In the case of this service, an NF corresponding to the service NF provides a function of providing policy information to the UE and identifying whether a policy has been enforced, and may be referred to as a PCF, an ePCF, a policy NF, etc.
UE Configuration service: This may refer to a service in which a home PLMN or a serving PLMN provides, to the UE, configuration information to be used by the UE. The configuration information may include various pieces of information such as service area restriction information, accessible femto cell IDs, network slice configuration information, and non-3GPP access connection information. In the case of this service, an NF corresponding to the service NF provides a function of providing configuration information to the UE and identifying whether the configuration information has been properly received, and may include various NFs, such as an AMF, an eAMF, an SMF, an eSMF, a PCF, an ePCF, a policy NF, a UDM, and an eUDM, depending on the configuration information.
Network Selection configuration service: This may refer to a service in which a home PLMN provides configuration information to control network selection and PLMN selection of the UE. In the network selection configuration service, information provided by the home PLMN to the UE may include one or more of the following: a list of preferred PLMN IDs, a list of preferred RATs, and a list of supported RAT(s) and/or service(s) for each PLMN in the list of preferred PLMN IDs. In the case of this service, an NF corresponding to the service NF provides a function of providing information necessary for PLMN selection to the UE and identifying whether the information has been received, and may be referred to as a UDM, an eUDM, a steering of roaming (SoR) AF, an SoR function, etc.

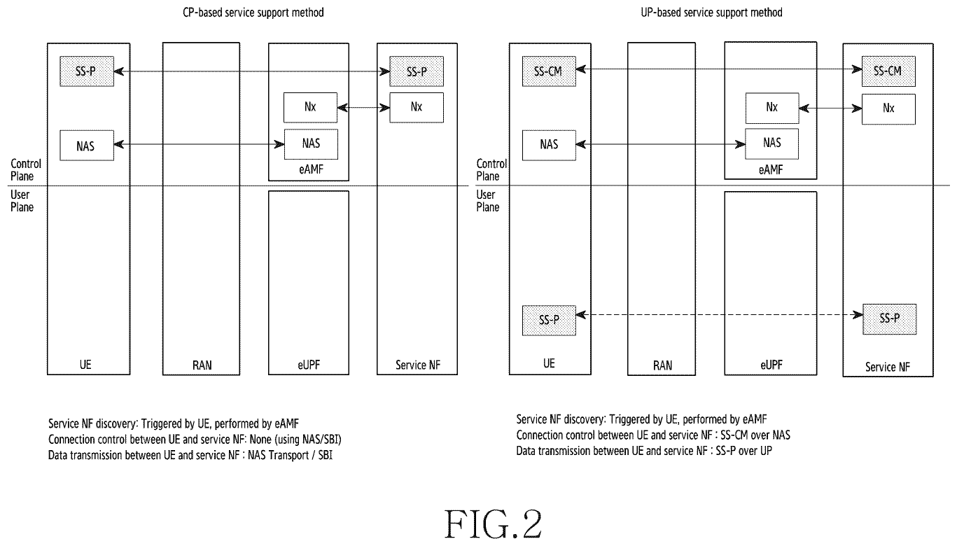

FIG. 2 illustrates an example of a CP-based service support method and a UP-based service support method according to an embodiment.

More specifically, FIG. 2 may illustrate a protocol stack of a CP-based service support method and a UP-based service support method. The UP-based service support method may refer to a method for transmitting service data that is logically or physically separated from a CP. The UP-based service support method may also be referred to as a service plane (SP)-based support method. In this case, an SP may be a new plane which is logically or physically separated from a CP or a UP of a mobile communication network to transmit service data. In FIG. 2, service specific connection management (SS-CM) and service specific protocol (SS-P) may conceptually define communication functions required for a service, and the same may be as follows.
SS-CM: The SS-CM may control establishment/release of a secure UP connection (a transport layer security (TLS)/Internet protocol (IP)-or QUIC/IP-based connection) between a UE and a service NF, and manage a connection state. A separate protocol may exist for each service. For example, in the case of an LCS, a UPP-CM may exist.
SS-P: The SS-P may define a procedure and a payload for transmitting and receiving data (e.g., a service-specific message (SS-M)) for a service between the UE and the service NF. A secure UP connection (a TLS/IP-or QUIC/IP-based connection) between the UE and the service NF or a connection (NAS/SBI) through an eAMF may be used. Various protocols may exist depending on a service. For example, in the case of an LCS, an LCS-UPP may exist.

In the case of the CP-based service support method, the UE may transmit and receive an SS-P message through an NAS connection and an interface between NFs.

Referring to FIG. 2, in the case of the CP-based service support method, the UE may transmit and receive an SS-P message through an NAS connection and an interface (Nx) between NFs.

In FIG. 2, since the UE does not maintain a separate connection with the service NF, a separate connection control function between the UE and the service NF may not exist.

The eAMF may perform discovery of the service NF for the UE. For example, in the case of the CP-based service support method, the eAMF may perform discovery of the service NF for the UE, such as obtaining and determining an address of the service NF.

In the case of the UP-based service support method (or an SP-based service support method, that is, a method for transmitting service data that is logically or physically separated from a CP), the UE may transmit and receive a message for SS-CM through an NAS connection and an interface between NFs. In the case of the UP-based service support method, the UE may transmit and receive a message for SS-CM through an NAS connection and an interface (Nx) between NFs. The UE may transmit and receive a message for SS-P through a connection (e.g., a connection through an SP) between service NFs through a UP (or SP).

In the case of the UP-based service support method, when the UE transmits a UP connection establishment request message for a service to the eAMF, the eAMF may obtain an address of a service NF for a service type corresponding to the request message from an evolved network repository function (eNRF), determine the service NF for the UE, and then transmit, to the service NF, the UP connection establishment request message received from the UE. When the service NF receives the UP connection establishment request message, the service NF may generate a service-specific association ID (or binding ID) for the UE and transmit, to the UE through the eAMF, a UE connection Est. Command message including a UP address of the service NF and the association ID. When the UE receives the UE connection Est. Command message including the UP address of the service NF and the association ID, the UE may first establish an IP PDU session in order to establish a UP connection for a service, and then establish a secure connection (e.g., a TLS connection or a QUIC connection) with the service NF by using the previously received UP address of the service NF. The UE may transmit a UP session establishment request message including the association ID to the service NF in order to associate the secure connection with the UE. When a UE ID corresponding to the received association ID exists, the service NF may associate the corresponding secure connection with the UE ID, and transmit a UP session establishment success message to the UE. When the UE receives the UP session establishment success message, the UE may transmit and receive data for a service through a UP session. The UE may transmit, to the service NF, a message indicating that the UP session establishment has succeeded, via a NAS message through the eAMF.

In the CP-based service support method, since the data for the service shares a control plane resource with basic functions (e.g., mobility control, session control, authentication, etc.), this may cause a burden in a situation in which a control plane is congested.

In accordance with an embodiment of the disclosure, a method is provided for determining at least one of a CP-based service support scheme or a UP-based service support scheme with respect to supported services. Through the disclosure, it is possible to alleviate the burden on a CP depending on a situation.

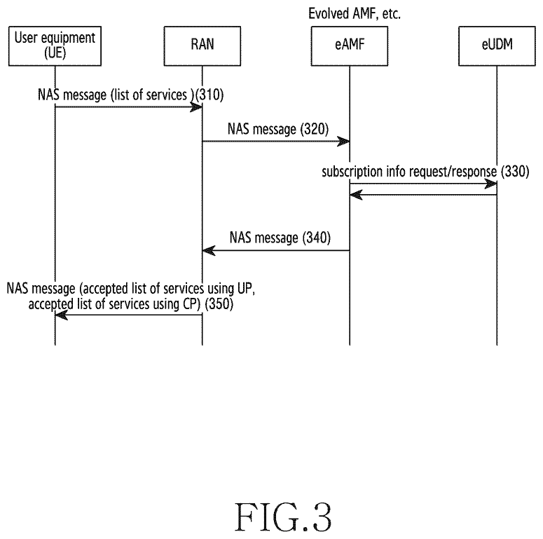

FIG. 3 is a signal flow diagram illustrating a registration procedure of a UE according to an embodiment.

Referring to FIG. 3, in step 310, a UE may transmit an AN message (AN parameter or NAS message) to a base station (or RAN). The AN message may be a message transmitted and received between the UE and the base station. When the UE supports UP-based transmission (i.e., UP-based service-related traffic transmission), the UE may include, in the AN message, an indicator indicating that a corresponding function is supported.

The NAS message in step 310 of FIG. 3 may be a message transmitted and received between the UE and a CN (e.g., an eAMF). However, the name of the message transmitted and received between the UE and the CN is not limited to the example of step 310, and may be referred to by a different name.

The NAS message may be at least one type of message among a registration request message and a service request message.

The registration request message may refer to a message transmitted for the purpose of initial access for initiation of a mobile communication service of the UE. The registration request message may refer to a message transmitted for the purpose of periodically reporting the location of the UE to the network. The registration request message may refer to a message transmitted for the purpose of reporting to the network when the location (e.g., a TA) of the UE has changed.

The service request message may refer to a message transmitted for the purpose of establishing a connection (e.g., an N1+ connection) when the UE has no network connection with a core (e.g., CM_IDLE). The service request message may refer to a message transmitted for the purpose of notifying an information change when a change in state information and/or configuration information of the UE has occurred.

A NAS message (e.g., a registration request message) transmitted by the UE to the eAMF may include at least one of a UE ID (e.g., a subscription concealed ID (SUCI), a 5G-globally unique temporary identity (5G-GUTI), a 6G-globally unique temporary identity (6G-GUTI), or a permanent equipment ID (PEI)), a registration type, and information indicating CN-related support functions of the UE (e.g., 6G UE MM CN capability or 5G UE MM CN capability).

The UE may support various 5G/6G services. The UE may include information on a supported service in the NAS message. For example, the UE may include at least one of the following services in the NAS message.
LCS: This may include a service that provides the location of the UE or a service which receives the location of the UE from the network. In the LCS, an NF corresponding to a service NF may provide the LCS, and may be referred to as an LMF or an eLMF.
Sensing service: This may include a service through UE-based sensing information. This service may include functions such as object detection, fall detection, user health information (e.g., heart rate, blood pressure information, etc.), speed and location information, and a collision notification service. In the sensing service, an NF corresponding to the service NF may provide the sensing service, and may be referred to as a sensing NF, an ISAC NF, etc.
AI Data collection service: This may include a service which collects data necessary for AI model training for AI model-based communication. This service may include a function of transmitting, by the UE, data necessary for AI model training to the network, a function of receiving, by the UE, data necessary for AI model training from the network, etc. In the AI data collection service, an NF corresponding to the service NF may provide a data collection and provision service. In the AI data collection service, the NF corresponding to the service NF may be referred to as a DCNF, an AI NF, a DSNF, etc.
UE Policy service: This may include a service in which a home PLMN provides, to the UE, policy information that the UE is required to follow. The UE policy service may include a URSP rule (i.e., a rule indicating which network path the UE is required to use with respect to traffic to be transmitted and received. The UE may determine, based on the URSP rule, the DNN and/or network slice of a session through which application traffic is to be transmitted or received.), an AN selection rule (a rule indicating which non-3GPP AN the UE is to select), etc. In the UE policy service, an NF corresponding to the service NF may provide a function of providing policy information to the UE and identifying whether a policy has been enforced. In the UE policy service, the NF corresponding to the service NF may be referred to as a PCF, an ePCF, a policy NF, etc.
UE Configuration service: This may include a service in which a home PLMN or a serving PLMN provides, to the UE, configuration information to be used by the UE. The configuration information may include information such as service area restriction information, accessible femto cell IDs, network slice configuration information, and non-3GPP access connection information. In the UE configuration service, an NF corresponding to the service NF may provide a function of providing configuration information to the UE and identifying whether the configuration information has been properly received. In the UE configuration service, the NF corresponding to the service NF may include various NFs, such as an AMF, an eAMF, an SMF, an eSMF, a PCF, an ePCF, a policy NF, a UDM, and an eUDM, depending on the configuration information.
Network selection configuration service: This may include a service in which a home PLMN provides configuration information to control network selection and PLMN selection of the UE. In the network selection configuration service, information provided by the home PLMN to the UE may include at least one of the following: a list of preferred PLMN IDs, a list of preferred RATs, and a list of supported RAT(s) and/or service(s) for each PLMN in the list of preferred PLMN IDs. In the network selection configuration service, an NF corresponding to the service NF may provide a function of providing information for PLMN selection to the UE and identifying whether the information has been received. In the network selection configuration service, the NF corresponding to the service NF may be referred to as a UDM, an eUDM, an SoR AF, an SoR function, etc.

The UE may support a service in two schemes. The UE may perform data transmission and reception for a corresponding service by using a CP, which may be referred to as CP-based transmission. The UE may perform data transmission and reception for a corresponding service by using a UP, which may be referred to as UP-based transmission. The term UP-based transmission may also be used interchangeably with SP-based transmission. An SP may be a new plane which is logically or physically separated from a control UP in a mobile communication network to transmit service data. The SP has the advantage of reducing the load on the CP and allowing a technology to be developed independently of the CP. Transmission on the SP may be performed through the UP.

The UE may include, in a message transmitted to the eAMF, not only information on supported service(s) but also information indicating a transmission method (e.g., at least one of a CP-based transmission method or a UP-based transmission method) supported for each service. The UE may also include, in the message transmitted to the eAMF, a list of services supporting a CP-based transmission method and a list of services supporting a UP-based transmission method.

When the UE commonly supports (or requests) a UP-based transmission scheme for multiple services, the UE may include, in a registration request message, an indicator indicating that a corresponding function is supported. The corresponding indicator may be included in information indicating CN-related support functions of the UE.

The corresponding indicator may be expressed in various forms. For example, the indicator may be expressed as “Support of UP-based Service offloading”, “Support of UP-based Service”, etc. However, the disclosure is not limited thereto.

In step 320, when an AN message received from the UE includes a UP-based transmission (or UP-based offloading) indicator, a RAN may select the eAMF which supports the corresponding function.

The RAN may transfer an N2+ message (N2+ parameters and a registration request) to the eAMF. The N2+ parameters may include a selected PLMN ID and UE location information (e.g., location information, a cell ID associated with a cell on which the UE is camping, a RAN node ID, etc.).

In step 330, the eAMF may obtain subscriber information on the UE from an eUDM. The subscriber information may include information indicating that the UP-based transmission scheme is allowed. Information indicating whether the UP-based transmission scheme is allowed may be provided for each of various services (e.g., an LCS, a UE configuration service, a network selection service, etc.) which may be supported by the UE, according to step 320.

In step 340, the eAMF may determine whether to perform UP-based transmission for each service, based on the information included in the NAS message received from the UE in step 320 and the information received from the eUDM.

The eAMF may determine to perform UP-based transmission only for services for which the UP-based transmission scheme is allowed, based on the subscriber information on the UE obtained in step 330.

For service(s) for which the subscriber information on the UE does not include information disallowing the UP-based transmission scheme, the eAMF may determine to perform the UP-based transmission scheme with respect to the services in a NAS congestion situation.

When the NAS congestion situation is resolved, the eAMF may change the transmission scheme to a CP-based transmission scheme with respect to the services which have previously used the UP-based transmission scheme.

When the eAMF selects a transmission scheme for the UE and the requested service(s), the eAMF may include, in a NAS message (e.g., registration accept, registration reject, service accept, or service reject) transmitted to the UE, a list of services for which the UP-based transmission scheme is allowed, a list of services for which the UP-based transmission scheme is rejected, a list of services for which the CP-based transmission scheme is allowed, a list of services for which the CP-based transmission scheme is rejected, etc. Each list may include service(s) allowed according to the determination.

In step 350, when the RAN receives the message according to step 340 from the eAMF, the RAN may transmit, to the UE, the NAS message included in the message according to step 340.

For services included in an accepted list of services using UP in the NAS message received from the eAMF, the UE may transmit a NAS message including a UP connection establishment request message (e.g., the SS-CM message described in FIG. 2) for each service.

For services included in an accepted list of services using CP in the NAS message received from the eAMF, the UE may transmit a NAS message including service data (e.g., the SS-M message described in FIG. 2) for each service.

For a service included in both the accepted list of services using UP and the accepted list of services using CP in the NAS message received from the eAMF, the UE may select one of the CP-based transmission scheme or the UP-based transmission scheme, and then perform a procedure corresponding to the selected scheme.

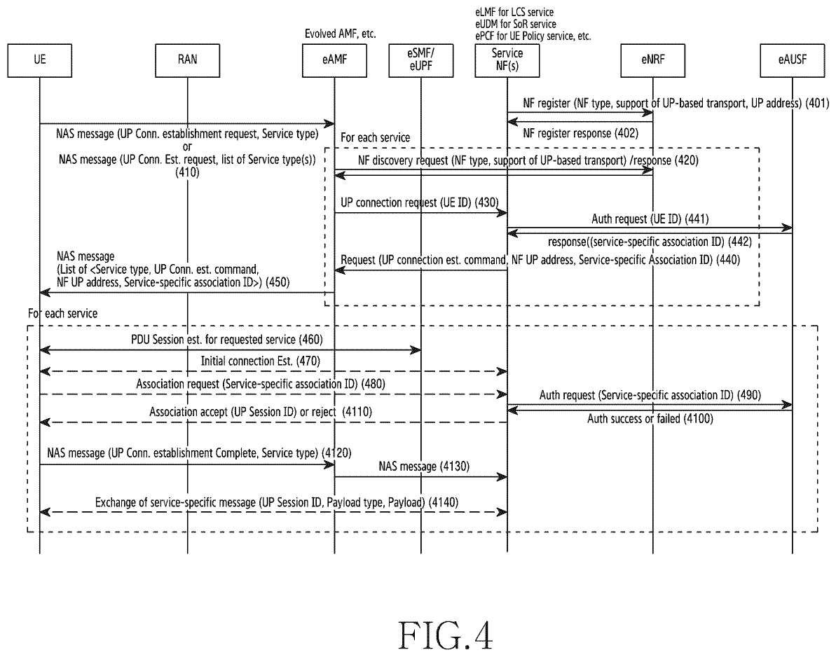

FIG. 4 is a signa flow diagram illustrating a procedure for controlling a service-specific UP connection, according to an embodiment.

Referring to FIG. 4, in step 401, a service NF may perform an NF registration request to an eNRF. The registration request message may include at least one of an NF type, whether UP-based transmission (UP-based transport) is supported, and a UP address (e.g., a fully qualified domain name (FQDN) or an IP address). For example, the NF type may be an NF type indicating a service-specific service NF according to FIG. 1. For example, when a function provided by a service NF in a UP-based transmission method according to FIG. 2 is supported, it may indicate that UP-based transmission is supported.

In step 402, when the eNRF receives an NF registration request message, the eNRF may update a state of a corresponding NF. When the eNRF receives the NF registration request message, the eNRF may store a corresponding NF profile. The NF profile may include an indicator indicating that the UP-based transmission method is supported.

In step 410, the UE may transmit, to an eAMF through a RAN, a NAS message including a UP connection establishment request message for a service. The NAS message may include a UP Conn. Est. request message and a corresponding service type (e.g., at least one of an LCS, a UE policy service, sensing, and AI data collection). When the UE transmits UP connection establishment request messages for multiple service types, the NAS message may include the corresponding service type(s).

In step 420, when the eAMF receives the UP Conn. Est. request message from the UE, the eAMF may transmit an NF discovery request message to the eNRF to obtain an address of an NF for the corresponding service type. The NF discovery request message may include an NF type configured for the NF for the service type received from the UE (or a service type corresponding to the received UP Conn. Est. request message) (referring to the description of the service example in FIG. 1, e.g., in the case of an LCS, the NF type may be configured as a value indicating an LMF) or an indicator indicating support for UP-based transmission.

When an NF discovery message includes the NF type and the indicator indicating support for UP-based transmission, the eNRF may include, in a response message transmitted to the eAMF, NF profiles including information indicating support for UP-based transmission, among NF profiles for the NF type.

In step 430, the eAMF may select an NF which supports the service type of the message received in step 410 and supports UP-based service data transmission, based on at least one of the information obtained in step 420 or configuration information. The eAMF may transmit, to the corresponding service NF, a UE ID for the UE having transmitted the message in step 410 along with the UP Conn. Est. request message.

In step 440, when the message received from the eAMF includes the UP Conn. Est. request message, the service NF may transmit, to the eAMF, a message including a service-specific association ID (or binding ID) for the UE ID included in the message received from the eAMF, and a UP address (e.g., an FQDN or an IP address) of the service NF, together with an indicator that the message is a UE Conn. Est. Command message.

When the message received by the service NF from the eAMF includes the UP Conn. Est. request message, the service NF may directly generate the service-specific association ID (or binding ID) for the UE ID included in the message received from the eAMF.

In step 441, when the message received by the service NF from the eAMF includes the UP Conn. Est. request message, the service NF may request an eAUSF to generate the service-specific association ID (or binding ID) for the UE ID included in the message received from the eAMF.

In step 442, the service NF may receive, from the eAUSF, the service-specific association ID (or binding ID) requested to be generated, and may use the same.

The service-specific association ID may be a key generated and derived from a secret key corresponding to the UE ID. That is, the eAUSF may generate a key for a service.

In step 450, the eAMF may include, in a NAS message transmitted to the UE, information included in the message received in step 440, and transmit the NAS message. The NAS message may include at least one of a UP Conn. Est. command, a service NF UP address, a service-specific association ID, and a service type. When the message in step 410 includes UP connection establishment requests for multiple service NFs, and at least some of steps 420, 430, 440, 441, or 442 are performed for the multiple service NFs, the eAMF may include messages for multiple services in the NAS message. For example, the NAS message may include, for each of the multiple services, a UP Conn. Est. Command, a service NF UP address, a service-specific association ID, and a service type.

In step 460, the UE may determine whether there is a PDU session to transmit a UP connection, based on the configuration information, for the service type included in the message received in step 450. When there is no suitable PDU session, the UE may transmit a PDU session establishment request message to an eSMF to obtain information (e.g., an IP address of the UE, etc.) on a PDU session, and may perform step 470 by using the allocated IP address. When there is a suitable PDU session, the UE may perform step 470 by using the IP address allocated for the corresponding PDU session.

In step 470, the UE may obtain an IP address of the service NF, based on the service NF UP address received in step 450. For example, when an FQDN of the service NF is included in step 450, the UE may obtain an IP address for the corresponding FQDN from a DNS server.

The UE may establish a secure connection (or initial connection) to the service NF by using the IP address of the service NF. The secure connection may be a TLS connection or a QUIC connection.

In step 480, the UE may transmit, through the secure connection, a request message including the service-specific association ID received in step 450 in order to associate the established secure connection. With regard to the above-described terms, the term “association” may be used interchangeably with “binding”, and an association ID and a binding ID may be used interchangeably.

In step 490, after receiving the message according to step 480, the service NF may perform authentication for the service-specific association ID. When the service NF directly performs the authentication for the service-specific association ID, the service NF may identify whether a UE ID corresponding to the service-specific association ID included in the received message is stored. When the UE ID corresponding to the service-specific association ID is stored, the service NF may determine that the authentication has succeeded and generate a UP session ID. When the service NF performs the authentication through the eAUSF, the service NF may transmit the received service-specific association ID to the eAUSF.

In step 4100, the eAUSF may receive an authentication request message according to step 490 to perform authentication, and then, when an authentication result is successful, include the authentication result and the UP session ID in a message transmitted to the service NF.

In step 4110, the service NF may transmit a response message for the request message according to step 480 to the UE. The message transmitted to the UE may include a processing result (e.g., an indicator indicating whether the association has succeeded or failed). When the authentication result according to step 490 is successful, the message transmitted to the UE may include the UP session ID.

In step 4120, when the UE receives a message indicating that the association has succeeded, the UE may transmit, to the service NF through the eAMF, a message indicating that the UP connection establishment has succeeded. The message transmitted by the UE to the eAMF may include an indicator indicating UP Conn. Est. Complete and a service type.

In step 4130, the eAMF may transmit the message received according to step 4120 to the corresponding service NF. When the service NF receives at least one of an indicator indicating UP Conn. Est. complete, a UE ID, or an association ID, the service NF may determine that a UP session has been established for the corresponding UE.

In step 4140, the UE and the service NF may transmit and receive service data to and from each other through an IP packet including a session ID, a payload type, and a payload.

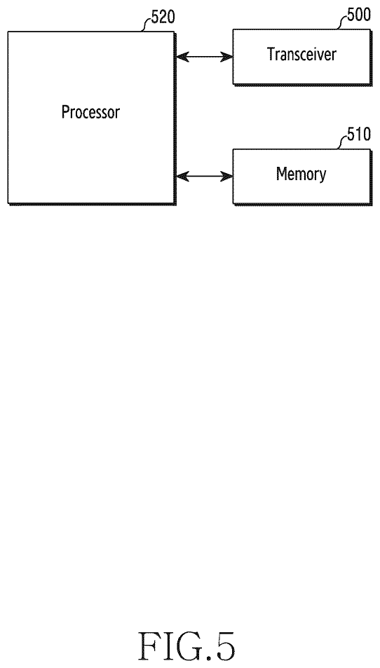

FIG. 5 illustrates a UE according to an embodiment.

Referring to FIG. 5, the UE includes a processor 520, a transceiver 500, and a memory 530. However, components of the UE are not limited to the above-described example. For example, the UE may include more or less components than the above-described components. In addition, the processor 520, the transceiver 500, and the memory 510 may be implemented in the form of a single chip.

The processor 520 may control a series of processes so that the UE can operate according to the above-described embodiments of the disclosure. For example, the processor 520 may control the components of the UE in order to perform the user plane-based service discovery method according to the above-described embodiments. The processor 520 may control the components of the UE to perform the embodiments of the disclosure by executing the programs stored in the memory 510. In addition, the processor 520 may be an application processor (AP), a communication processor, a circuit, an application-specific circuit, or at least one processor.

The transceiver 500 may transmit/receive signals with network entities, other UEs, or base stations. The signals transmitted/received with network entities, other UEs, or base stations may include control information and data. The transceiver 500 may include an RF transmitter configured to up-convert and amplify the frequency of transmitted signals, an RF receiver configured to low-noise-amplify received signals and down-convert the frequency thereof, etc. However, this is only an embodiment of the transceiver 500, and the components of the transceiver 500 are not limited to the RF transmitter and the RF receiver. In addition, the transceiver 500 may receive signals through a radio channel, output the same to the processor 520, and transmit signals output from the processor 520 through the radio channel.

The memory 510 may store programs and data necessary for operations of the UE. In addition, the memory 510 may store control information or data included in signals transmitted/received by the UE. The memory 510 may include storage media such as a read only memory (ROM), a random access memory (RAM), a hard disk, a compact disc-ROM (CD-ROM), a digital versatile disc (DVD), or a combination of storage media. In addition, the memory 510 may include multiple memories. Furthermore, the memory 510 may store programs for executing the above-described user plane-based service discovery method.

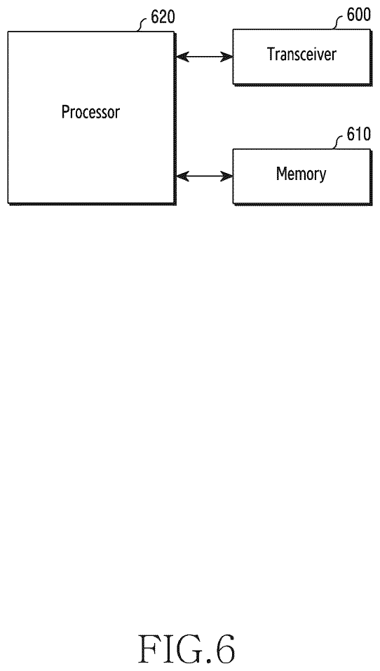

FIG. 6 illustrates a base station according to an embodiment.

Referring to FIG. 6, the base station includes a processor 620, a transceiver 600, and a memory 610. However, components of the base station are not limited to the above-described example. For example, the base station may include more or less components than the above-described components. In addition, the processor 620, the transceiver 600, and the memory 610 may be implemented in the form of a single chip.

The processor 620 may control a series of processes so that the base station can operate according to the above-described embodiments of the disclosure. For example, the processor 620 may control the components of the base station in order to perform the user plane-based service discovery method according to the above-described embodiments. The processor 620 may control the components of the base station to perform the embodiments of the disclosure by executing the programs stored in the memory 610. In addition, the processor 620 may be an AP, a communication processor, a circuit, an application-specific circuit, or at least one processor.

The transceiver 600 may transmit/receive signals with network entities, other base stations, or UEs. The signals transmitted/received with network entities, other base stations, or UEs may include control information and data. The transceiver 600 may include an RF transmitter configured to up-convert and amplify the frequency of transmitted signals, an RF receiver configured to low-noise-amplify received signals and down-convert the frequency thereof, etc. However, this is only an embodiment of the transceiver 600, and the components of the transceiver 600 are not limited to the RF transmitter and the RF receiver. In addition, the transceiver 600 may receive signals through a radio channel, output the same to the processor 620, and transmit signals output from the processor 620 through the radio channel.

The memory 610 may store programs and data necessary for operations of the base station. In addition, the memory 610 may store control information or data included in signals transmitted/received by the base station. The memory 610 may include storage media such as a ROM, a RAM, a hard disk, a CD-ROM, a DVD, or a combination of storage media. In addition, the memory 610 may include multiple memories. Furthermore, according to an embodiment, the memory 620 may store programs for executing the above-described user plane-based service discovery method.

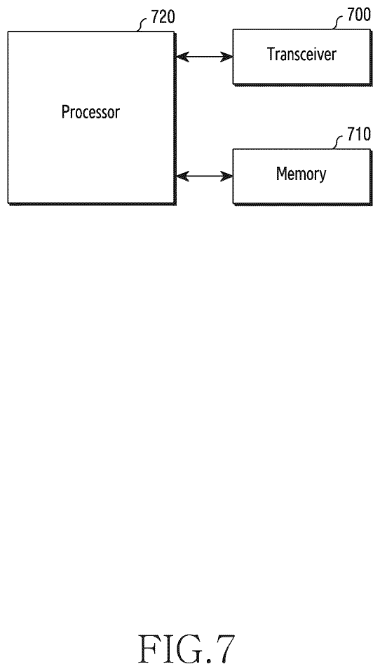

FIG. 7 illustrates a network entity according to an embodiment.

Referring to FIG. 7, the network entity includes a processor 720, a transceiver 700, and a memory 710. However, components of the network entity are not limited to the above-described example. For example, the network entity may include more or less components than the above-described components. In addition, the processor 720, the transceiver 700, and the memory 710 may be implemented in the form of a single chip. Furthermore, the network entity may refer to an NF, and the NF may include an RAN, an AMF, a PCF, a UDM, an AF, an NEF, a UTM, etc.

The processor 720 may control a series of processes so that the NF can operate according to the above-described embodiments of the disclosure. For example, the processor 720 may control the components of the network entity in order to perform the user plane-based service discovery method according to the above-described embodiments. The processor 720 may control the components of the network entity to perform the embodiments of the disclosure by executing the programs stored in the memory 710. In addition, the processor 720 may be an AP, a communication processor, a circuit, an application-specific circuit, or at least one processor.

The transceiver 700 may transmit/receive signals with other network entities, base stations, or UEs. The signals transmitted/received with other network entities or UEs may include control information and data. The transceiver 700 may include an RF transmitter configured to up-convert and amplify the frequency of transmitted signals, an RF receiver configured to low-noise-amplify received signals and down-convert the frequency thereof, etc. However, this is only an embodiment of the transceiver 700, and the components of the transceiver 700 are not limited to the RF transmitter and the RF receiver. In addition, the transceiver 700 may receive signals through a radio channel, output the same to the processor 720, and transmit signals output from the processor 720 through the radio channel.

The memory 710 may store programs and data necessary for operations of the network entity. In addition, the memory 710 may store control information or data included in signals transmitted/received by the network entity. The memory 710 may include storage media such as a ROM, a RAM, a hard disk, a CD-ROM, a DVD, or a combination of storage media. In addition, the memory 710 may include multiple memories. Furthermore, the memory 710 may store programs for executing the above-described user plane-based service discovery method.

The configuration diagrams, illustrative diagrams of control/data signal transmission methods, and illustrative diagrams of operation procedures as illustrated in FIG. 1 to FIG. 7 are not intended to limit the scope of protection of the disclosure. That is, all the constituent units or operation steps shown in FIG. 1 to FIG. 7 should not be construed as essential elements for implementing the disclosure, and even when including only some of the elements, the disclosure may be implemented without impairing the true nature of the disclosure.

The above-described operations of the embodiments may be implemented by providing any unit of a device with a memory device storing corresponding program codes. That is, a controller in the device may perform the above-described operations by reading and executing the program codes stored in the memory device by means of a processor or central processing unit (CPU).

Various units or modules of an entity or terminal device set forth herein may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Methods disclosed in the claims or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a ROM, an electrically erasable programmable read only memory (EEPROM), a magnetic disc storage device, a CD-ROM, a DVD, or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), storage area network (SAN), or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A method performed by a network entity, the method comprising:
receiving a user plane (UP) connection establishment request message from a user equipment (UE);
transmitting, to an evolved network repository function (eNRF) entity, a network function (NF) discovery request message to obtain address information of a service NF entity;
receiving, from the eNRF entity, a response message including an NF profile identified based on the NF discovery request message;
selecting a service NF entity based on the received NF profile;
transmitting, to the selected service NF entity, identification information of the UE and the received UP connection establishment request message;
receiving, from the selected service NF entity, a message including at least one of binding identification information corresponding to the UE identification information or address information of the selected service NF entity;
transmitting, to the UE, a non-access stratum (NAS) message including at least one of the binding identification information or the address information of the selected service NF entity;
receiving, from the UE, information indicating whether a UP connection with the selected service NF entity is established; and
transmitting, to the selected service NF entity, the information indicating whether the UP connection is established.

2. The method of claim 1, further comprising, based on at least one of a transmission method supported by the UE or a network condition, determining at least one of a control plane (CP) based transmission method or a UP based transmission method.

3. The method of claim 1,
wherein the NF discovery request message includes at least one of service type information received from the UE or an indicator indicating support for UP based transmission.

4. The method of claim 1,
wherein selecting the service NF entity based on the received NF profile comprises selecting the service NF entity based on service type information included in the UP connection establishment request message received from the UE and whether the service NF supports UP based transmission.

5. A method performed by a user equipment (UE), the method comprising:
transmitting, to a network entity, a user plane (UP) connection establishment request message;
receiving, from the network entity, a non-access stratum (NAS) message including at least one of binding identifier (ID) information or address information of a service NF entity selected by the network entity;
transmitting, to an evolved session management function (eSMF) entity, a packet data unit (PDU) session establishment request message;
receiving, from the eSMF entity, information related to a PDU session;
establishing a secure connection with the service NF entity based on the address information of the service NF entity;
transmitting, to the service NF entity, a request message for associating the secure connection;
receiving, from the service NF entity, a response message including an indicator indicating whether the association is successful;
transmitting, to the network entity, a message indicating whether the UP connection is established; and
transmitting service data to the service NF entity.

6. The method of claim 5, wherein transmitting the UP connection establishment request message to the network entity comprises:
receiving, from the network entity, a message including a list of services according to a transmission method determined by the network entity; and
transmitting, to the network entity, the UP connection establishment request message requesting UP connection establishment for a service supporting the UP based transmission method.

7. The method of claim 5, wherein establishing the secure connection with the service NF entity based on the address information of the service NF entity comprises:
identifying an Internet Protocol (IP) address of the service NF entity based on the address information of the service NF entity; and
establishing the secure connection with the service NF entity based on the IP address of the service NF entity.

8. The method of claim 5,
wherein the UP connection establishment request message includes service type information.

9. A network entity comprising:
at least one processor; and
at least one memory, communicatively coupled to the at least one processor, storing instructions executable by the at least one processor individually or in any combination to cause the network entity to:
receive a user plane (UP) connection establishment request message from a user equipment (UE),
transmit, to an evolved network repository function (eNRF) entity, a network function (NF) discovery request message to obtain address information of a service NF entity,
receive, from the eNRF entity, a response message including an NF profile identified based on the NF discovery request message,
select a service NF entity based on the received NF profile,
transmit, to the selected service NF entity, identification information of the UE and the received UP connection establishment request message,
receive, from the selected service NF entity, a message including at least one of binding identification information corresponding to the UE identification information or address information of the selected service NF entity,
transmit, to the UE, a non-access stratum (NAS) message including at least one of the binding identification information or the address information of the selected service NF entity,
receive, from the UE, information indicating whether a UP connection with the selected service NF entity is established, and
transmit, to the selected service NF entity, the information indicating whether the UP connection is established.

10. The network entity of claim 9, wherein the instructions further cause the network entity to:
based on at least one of a transmission method supported by the UE or a network condition, determine at least one of a control plane (CP) based transmission method or a UP based transmission method.

11. The network entity of claim 9,
wherein the NF discovery request message includes at least one of service type information received from the UE or an indicator indicating support for UP based transmission.

12. The network entity of claim 9, wherein the instructions further cause the network entity to:
select the service NF entity based on service type information included in the UP connection establishment request message received from the UE and whether the service NF supports UP based transmission.

13. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
transmit, to a network entity, a user plane (UP) connection establishment request message,
receive, from the network entity, a non-access stratum (NAS) message including at least one of binding identifier (ID) information or address information of a service NF entity selected by the network entity,
transmit, to an evolved session management function (eSMF) entity, a packet data unit (PDU) session establishment request message,
receive, from the eSMF entity, information related to a PDU session,
establish a secure connection with the service NF entity based on the address information of the service NF entity,
transmit, to the service NF entity, a request message for associating the secure connection,
receive, from the service NF entity, a response message including an indicator indicating whether the association is successful,
transmit, to the network entity, a message indicating whether the UP connection is established, and
transmit service data to the service NF entity.

14. The UE of claim 13, wherein the instructions further cause the UE to:
receive, from the network entity, a message including a list of services according to a transmission method determined by the network entity, and
transmit, to the network entity, the UP connection establishment request message requesting UP connection establishment for a service supporting the UP based transmission method.

15. The UE of claim 13, wherein the instructions further cause the UE to:
identify an Internet Protocol (IP) address of the service NF entity based on the address information of the service NF entity, and
establish the secure connection with the service NF entity based on the IP address of the service NF entity.

16. The UE of claim 13, wherein the UP connection establishment request message includes service type information.
